(19) United States
(12) Patent Application Publication
(10) Pub. No.: US 2007/0036135 A1
(43) Pub. Date: Feb. 15, 2007

(54) Communication identification system

(75) Inventors: David Patron, Cedar Park, TX (US); Sreenivasa Gorti, Austin, TX (US); Satish Parolkar, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/189,096

(22) Filed: Jul. 25, 2005

(51) Int. Cl. H04L 12/66

(52) U.S. Cl. 370/352

(57) ABSTRACT

A system and method of handling communication information associated with a communication request is disclosed. The system includes a computer readable memory that includes a data file that represents one or more documents that may be viewed by a plurality of users associated with the document, and a computer system having access to the computer readable memory and including logic to access the data file so that the one or more documents can be displayed and viewed by at least one of the plurality of users. Upon accessing the data file, presence information for at least a subset of the plurality of users associated with the one or more documents is provided to at least one of the plurality of users. In a particular embodiment, the one or more documents include a subject, and the subject is extracted from the data file and is communicated to another user after the document is displayed.

### FIELD OF THE DISCLOSURE

The disclosure relates to a system and method for presenting information associated with a communication request.

### BACKGROUND

In recent years, the advent of wireless phones, text messaging, and other communication methods have allowed people to communicate with each other more frequently. In addition, contact information has become easier to obtain, leading to more potentially unwanted communication requests. Caller identification information has been used to identify a caller of a telephony device. The caller identity information can allow a user to determine whether to answer a call. However, the information provided by caller identification is typically limited, such as a name or a phone number.

Accordingly, there is a need for an improved system and method to present information associated with a communication request.

### BRIEF DESCRIPTION OF THE DRAWINGS

FIG. 1 is a block diagram of an exemplary embodiment of a communication network incorporating presence information;

FIG. 2 is a block diagram of an exemplary embodiment of an originating computer that has access to the network of FIG. 1;

FIG. 3 illustrates a particular embodiment of an information display incorporating presence information;

FIG. 4 is a block diagram of a particular embodiment of a wireless telephone including an information display;

FIG. 5 is a flow chart illustrating a method of accessing a data file; and

FIG. 6 is a flow chart illustrating a method of receiving a communication request.

### DETAILED DESCRIPTION OF THE DRAWINGS

A system and method of communication information associated with a communication request is disclosed. The system includes a computer readable memory that includes a data file that represents one or more documents that may be viewed by a plurality of users associated with the document, and a computer system having access to the computer readable memory and including logic to access the data file so that the one or more documents can be displayed and viewed by at least one of the plurality of users. Upon accessing the data file, presence information for at least a subset of the plurality of users associated with the one or more documents is provided to at least one of the plurality of users. In a particular embodiment, the one or more documents include a subject, and the subject is extracted from the data file and is communicated to another user after the document is displayed.

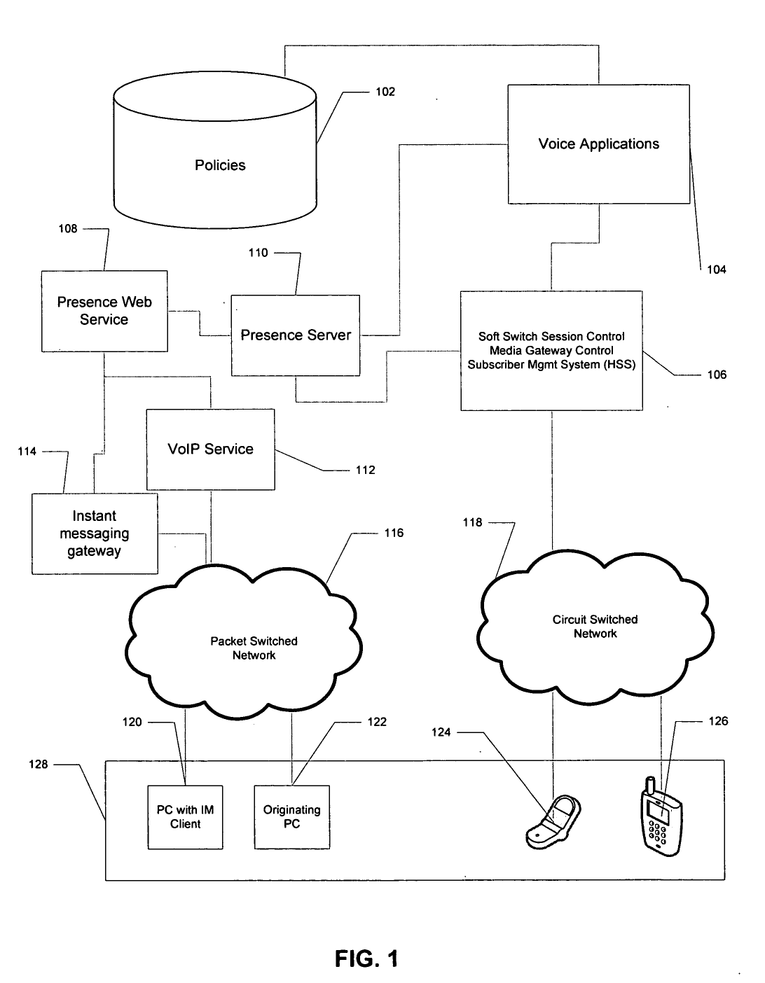

Referring to FIG. 1, a network incorporating presence information is shown. The network includes a policies server 102 and a voice applications system 104. The system further includes a soft switch session control, media gateway control, subscriber management system 106. The system also includes a presence web service 108 and a presence server 110, along with a voice over internet protocol (VOIP) service 112 and an instant messaging gateway 114. The network incorporates a packet switched network 116 and a circuit switch network 118. The system further includes user interfaces 128, including a personal computer with an instant messaging client 120, an originating personal computer 122, a wireless phone 124, and a landline phone 126. The system also includes an Internet Protocol (IP) based telephone 140. In a particular embodiment, the IP-based telephone 140 is a wireless telephone. In another particular embodiment, the IP-based telephone 140 is a wired telephone.

Presence information may be obtained from the presence server 110 via the presence web service 108. The presence information may be associated with a document opened at the originating personal computer 122. The presence information may be communicated via the packet switched network 116. The presence web service 108 and the presence server 110 are coupled to the VOIP service 112 and the instant messaging gateway 114. The instant messaging gateway 114 and the VOIP service 112, together with the presence server 110 and the presence web service 108, are all coupled to the packet switched data network 116. The presence server 110 is also coupled to the voice applications system 104 and the soft switch session controls system 106. The voice applications system 104 is coupled to the policy server 102. The soft switch session control system 106 is coupled to the circuit switch network 118. The wireless phone 124 and the landline phone 126 are each coupled to the circuit switch network 118. The IP-based telephone 140 is coupled to the packet switched data network 116.

In operation, a user may access a data file at the originating personal computer (PC) 122. The data file may be associated with a plurality of users including a user operating the personal computer 120, the wireless phone 124, the landline phone 126, or the IP-based telephone 140. A data file may be associated with document. For example, a data file may store a document viewable by a user on the personal computer 120. Upon opening a document at the originating PC 122, presence information may be accessed at the presence server 110 via the presence web service 108. This presence information may be displayed at the originating PC 122. The user at the originating PC 122 may review the presence information and seek to initiate a communications session with one or more of the plurality of users listed in the displayed presence information. Upon a selection by the user at the originating PC 122, a communication request may be sent to another user. The communication request may include subject information associated with the data file. The subject information may be displayed at the destination user device, such as at personal computer 120, wireless phone 124, or landline phone 126.

In a particular embodiment, a user may set up policy criteria at the policy server 102. In a particular embodiment, a user can create a set of policies that determine how calls are handled based on the subject information. For example, a user may create a set of policies to send calls associated with a particular subject to voicemail. In another exemplary embodiment, a user may create a set of policies to forward calls associated with a particular subject to another device or to another user.

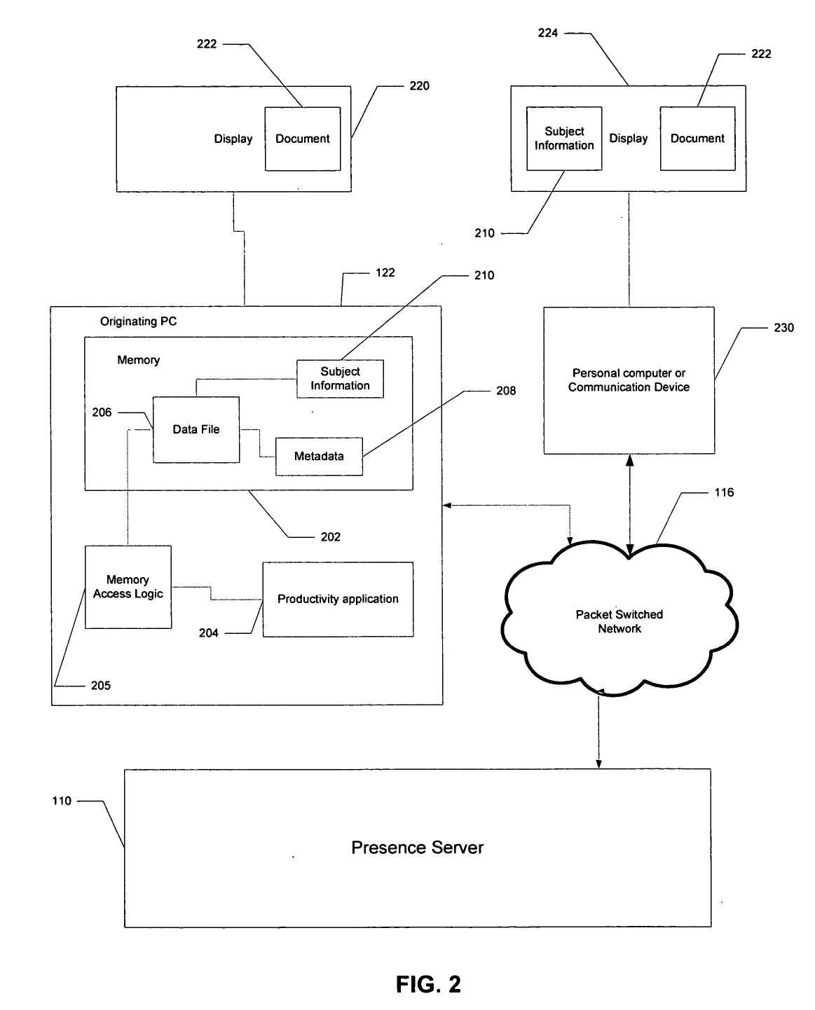

Referring to FIG. 2, a particular embodiment of an originating computer, such as originating personal computer 122, is illustrated. The originating personal computer 122 includes a memory 202, a productivity application 204, and memory access logic 205. The originating personal computer 122 also includes a display 220 and a document 222 shown at the display 220. The memory 202 includes a data file 206 associated with the document 222. The memory further includes metadata 208 and subject information 210 associated with the data file 206. The memory 202 is coupled to the memory access logic 205, which is further coupled to the productivity application 204. The computer 122 is coupled to the packet switched network 116 via a network interface. The packet switched network 116 is further coupled to a presence server 110 and other personal computer or communication devices 230. In a particular embodiment, the personal computer or communication device 230, may be the personal computer with the instant messaging client 120, the wireless phone 124, or the landline phone 126 illustrated in FIG. 1. The personal computer or communication device 230 is coupled to or has a display 224. The display 224 may display the subject information 210 and a portion or all of the document 222.

The data file 206 represents the document 222 that may be viewed by a plurality of users associated with the document. The memory access logic 205 may be used to access the data file so that the document 222 may be displayed and viewed by a user of the originating personal computer 122. Upon accessing the data file 206, presence information for the plurality of users associated with the document 222 is provided by the presence server 110 to the originating personal computer 122 via the packet switched network 116. The presence information provided by the presence server 110 indicates whether each user in a set of users associated with the document is available to communicate in real-time through an identified communication mechanism, such as a telephony mechanism or a computer network mechanism. In a particular embodiment, the computer network mechanism may include instant messaging, or a common workgroup-based productivity application, or a company-based intranet portal.

The document 222 is associated with the subject information 210. The subject information 210 may be extracted from the data file 206 and may be communicated to another user, such as a user of the personal computer or communication device 230, via the switch network 116 or via the circuit switch network 118 illustrated in FIG. 1. The extracted information may be stored by the personal computer or communication device 230 in a selected category based on the received subject information. The communication request may be placed in response to a user selection at the originating personal computer 122 in response to display information associated with the document 222. The display information may include a set of contacts that identify the plurality of users and the corresponding presence information for each of the pluralities of users. The presence information may identify a user, such as a user of the personal computer or communication device 230, as available for communication using a telephone device, such as wireless telephone 124 or landline telephone 126, as illustrated in FIG. 1. The subject information 210 is then communicated over a service provider network to the destination user device, such as wireless telephone 124 or landline telephone 126.

In a particular embodiment the user of the originating personal computer 122 may supply topic information associated with the data file 206. This topic information may be communicated to the packet switched network 116 or the circuit switch network 118 for display at the computer or communication device 230.

During operation, a first user of the originating personal computer 122 may display the document 222 on the display 220. The first user may further communicate with a second user of the computer or communication device 230 via a telephony connection while the first user is viewing the document 222. The communication session with the second user may be initiated by sending a system initiation protocol (SIP) message from the originating personal computer 122 to the packet switched network 116. The subject information 210 may be communicated to the communication device 230 using a subject heading field of the SIP message. In a particular embodiment, the personal computer or communication device 230 may be synchronized with the originating personal computer 122 to allow the document 222 to be displayed automatically after the subject information 210 has been received.

In a particular embodiment, the communication between the personal computer or the communication device 230 and the originating personal computer 122 may be initiated by sending a simple object access protocol (SOAP) message from the originating personal computer 122 to the personal computer or communication device 230. The subject information 210 may be communicated using extensible mark-up language (XML) data. In a particular embodiment, the metadata 208 is used to associate a plurality of users with the document 222. In another particular embodiment, the metadata 208 includes a universal resource locator (URL) associated with the document 222, to allow a user that does not have local access to the document 222 to retrieve the document. In a particular embodiment, the originating personal computer 122 and the memory 206 are disposed within a remote system. This remote system is accessible via a local computer having a web browser that is coupled to the remote system via a computer network. In another particular embodiment, information regarding the plurality of users associated with the document 222 is derived from contact information of an electronic address book stored at the originating personal computer 122.

During operation, the system illustrated in FIG. 2 may be used to display a document at a personal computer, and allow a user of that computer to access presence information for a plurality of users associated with the document. The user may further initiate communication sessions with the plurality of users and send subject information to those users via a telephone network. This allows the user to conduct a communication session related to the document with one or more of the plurality of users, even when the user is only available via a telephone. In a particular embodiment, the service can also reformat the subject information to make it suitable for display in a circuit-switched telephone device (for example, the metadata information may contain two fields, one for a full description of the topic, and one for a high-level short description that could be used in devices with limited display capabilities). In another particular embodiment, text-to-speech conversion may be performed on the subject information, and the converted subject information is transmitted as a preamble to be played for a user with a circuit-switched device that answers a call.

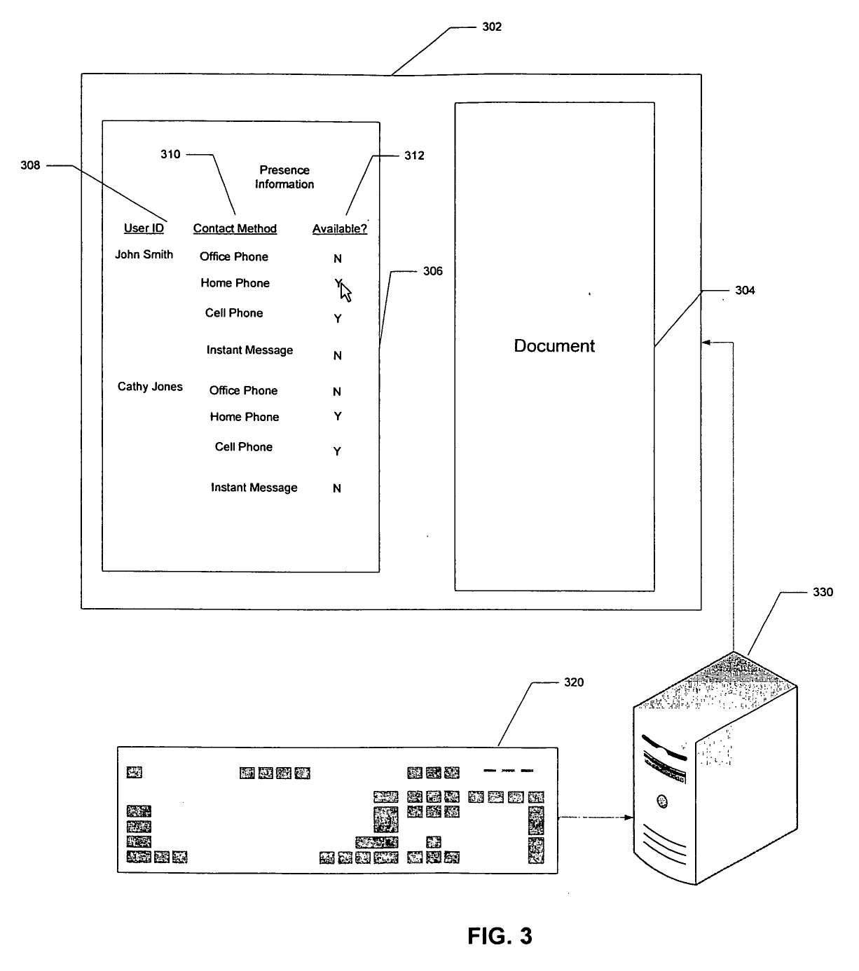

Referring to FIG. 3, a system for display of presence information is illustrated. The system includes a display 302, a computer system 330 and a keyboard 320. The display 302 includes a document window 304 and a presence window 306. The presence window 306 includes a plurality of fields, including a user field 308 to display a plurality of users, a communication path field 310 to display communication paths associated with each user, and a presence field 312 associated with each of the communication path field 310. A user of the computer system 330 may open the document 304, and the computer system 330 may then open the presence window 306 and display the presence information for users associated with the document 304. The presence window 306 displays presence information for the user. The user may review this presence information and determine if the user desires to conduct a communication session with a particular user associated with the document 304. The user of the computer system 330 may operate keyboard 320 or other appropriate input device, such as a computer mouse, to select an available communication method associated with a particular user listed in the user field 308. The communication path field 310 lists a variety of communication paths for each user listed in the user field 308. The presence field 312 indicates whether a particular communication path listed in the communication path field 310 is available for a particular user. The user of the computer system 330 may initiate a communication session with a particular user by selecting the appropriate communication option in the presence field 312. The communication path field 310 may include a variety of contact methods including instant messaging, or telephone contact methods, including a wide area network communication path such as wireline or wireless telephones accessible via a publicly switched network.

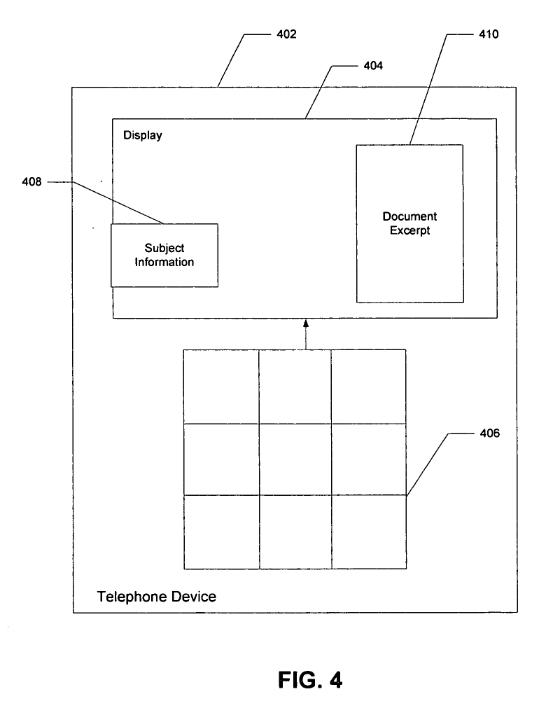

Referring to FIG. 4, a communication device for displaying subject information is illustrated. The communication device 402 includes a display 404 and a keypad 406. The display 402 may display subject information 408, and a document excerpt 410. During operation, the communication device 402 may receive subject information from an originating user after the originating user has accessed a document, and the user of the communication device is selected for a communication session at the originating user's communication device. For example, the originating user may access presence information associated with the document, and initiate a communication session to the communication device 402. As part of this communication session initiation, the originating user's device may transmit the subject information 408 to the communication device 402. The originating user's device may further provide the document excerpt 410 to the communication device 402. The user of the communication device 402 may review the subject information 408 and the document excerpt and determine whether to conduct a communication session with the originating user. The user of the communication device 402 may use the keypad 406 to respond to the communication request from the originating user. A communication device may be a personal data assistant, cell phone, landline phone, or other appropriate device. In a particular embodiment, if the user of the communication device 402 is unable to respond to the communication request, data associated with the communication request may be stored in a log together with the subject information 408. The user of the communication device 402 may review the log at a later time and determine the context of the call that was missed based on the subject information 408.

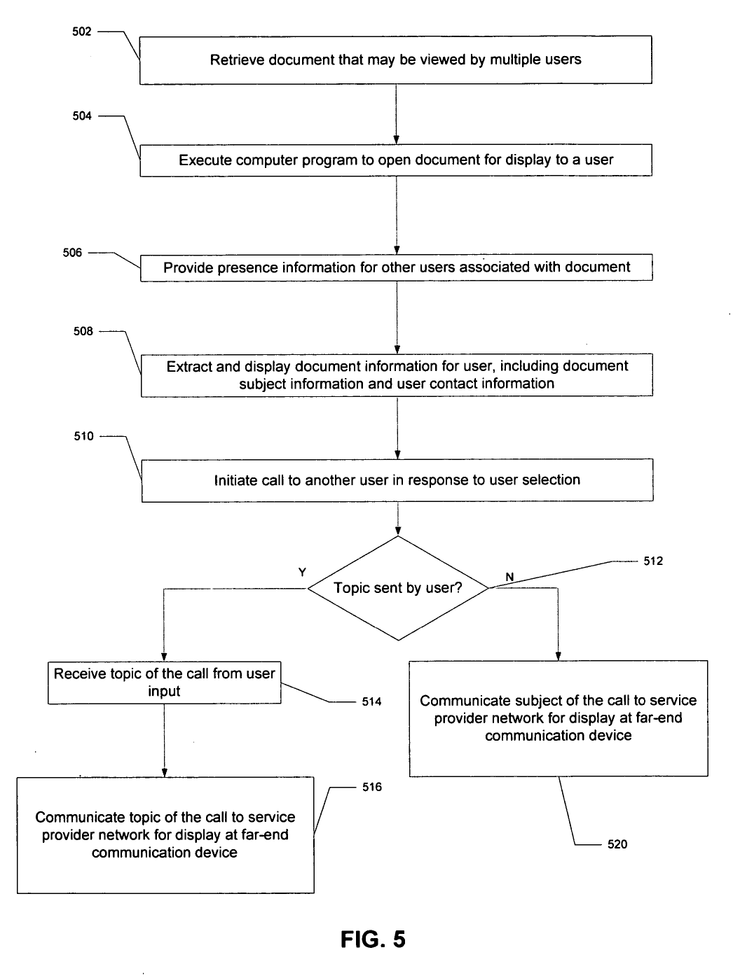

Referring to FIG. 5, a method of conducting a communication session among multiple users is illustrated. A document that may be viewed by multiple users is retrieved at 502. Proceeding to 504, a computer program is executed to open the document for display to a user. Presence information for other users associated with the document is provided, at 506. Moving to step 508, document information is extracted and displayed for the user, the document information including subject information and user contact information. Moving to step 510, a call or other communication session is initiated to another user, or users in a group call, in response to the first user's selection. At decision step 512, it is determined whether a topic has been sent by the user to the other user, or users, for the communication session. If a topic has been sent by the user, the method proceeds to step 514 and the topic of the call is received from user input. Proceeding to step 516, the topic of the call is communicated to the service provider network for display at a far end communication device. Returning to decision step 512, if the user does not desire to send a topic, the method proceeds to step 520 and a subject of the call is communicated to the service provider network for display at the far end communication device.

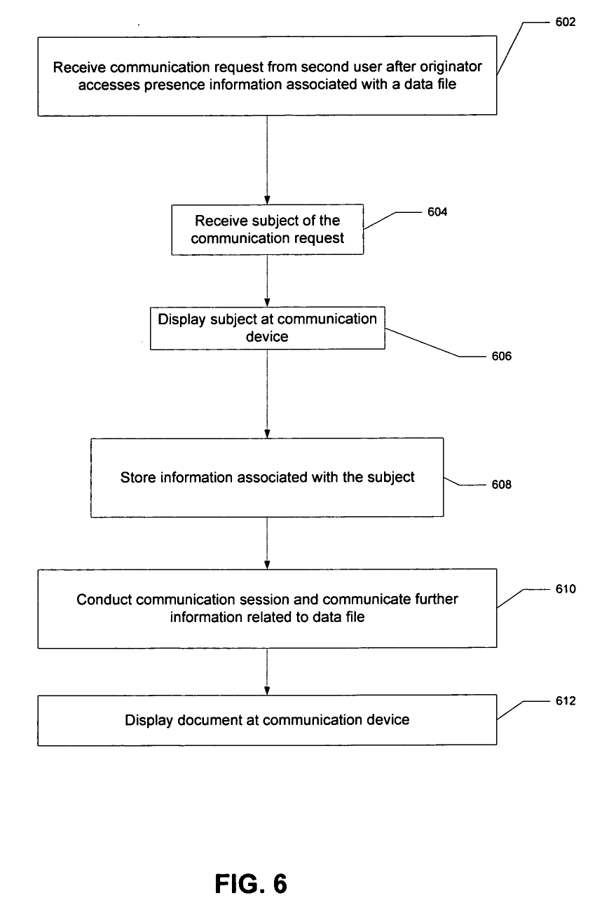

Referring to FIG. 6, a method for receiving a communication request is illustrated. A communication request is received after the originator of the communication request accesses presence information associated with a data file, at 602. Moving to step 604, a subject of the communication request is received. The subject of the communication request is displayed at a communication device, at step 606. Proceeding to step 608, information associated with the subject is stored. A communication session is conducted and further information related to the data file is communicated, at step 610. The communication session can include a voice call, text messaging, instant messaging, or other communication method, or a combination of communication methods. Moving to step 612, a portion, or all, of the document may be displayed at the communication device.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a computer readable memory that includes a data file that represents one or more documents that may be viewed, a plurality of users associated with the one or more documents;
a computer system having access to the computer readable memory and including logic to access the data file so that the one or more documents can be displayed and viewed by at least one of the plurality of users;
wherein upon accessing the data file, presence information for at least a subset of the plurality of users associated with the one or more documents is provided to at least one of the plurality of users.

2. The system of claim 1, wherein the at least one of the plurality of users is a first user that displays the one or more documents on a display device coupled to the computer system; and wherein the subset of the plurality of users includes each of the plurality of users except for the first user, such that the first user receives the presence information for all of the other users associated with the document.

3. The system of claim 1, wherein the presence information indicates whether a user is available to communicate through an identified communication mechanism.

4. The system of claim 3, wherein the communication mechanism includes a telephony mechanism and a computer network mechanism.

5. The system of claim 4, wherein the computer network mechanism includes instant messaging, workgroup-oriented applications, or intranet portals.

6. The system of claim 1, wherein the one or more documents includes a subject, and wherein the subject is extracted from the data file and is communicated to at least one of the plurality of users.

7. The system of claim 6, wherein the subject is sent to a remotely located communication device for display in connection with a call placed to the communication device.

8. The system of claim 7, wherein the call is rerouted based on policy criteria associated with the subject.

9. The system of claim 7, wherein the call is placed in response to a user selection made in response to display information associated with the one or more documents.

10. The system of claim 9, wherein the display information is a set of contacts that identify the plurality of users and corresponding presence information for each of the plurality of users.

11. The system of claim 10, wherein the presence information for a first user of the plurality of users identifies the first user as available for communication using a telephone device and wherein the call is placed and the subject is communicated over a service provider network to the telephone device.

12. The system of claim 11, wherein a topic of the call is provided by a user and the topic is communicated to the service provider network for display at the telephone device.

13. The system of claim 11, wherein the user that displays the one or more documents communicates with the first user via a telephony connection while the first user is also viewing a version of the one or more documents at a display device.

14. The system of claim 11, wherein the call is initiated by sending a session initiation protocol (SIP) message from the computer system to the service provider network.

15. The system of claim 14, wherein the subject is communicated using a subject header field of the SIP message.

16. The system of claim 11, wherein the call is initiated by sending a simple object access protocol (SOAP) message from the computer system to the service provider network.

17. The system of claim 11, wherein the subject is communicated using extensible markup language (XML) data.

18. The system of claim 1, wherein metadata is used to associate the plurality of users with the one or more documents.

19. The system of claim 18, wherein the metadata includes a universal resource locator (URL) associated with the one or more documents.

20. The system of claim 1, wherein the computer system and the computer readable memory are disposed within a system that is accessible via a second computer having a web browser, the second computer coupled to the system via a computer network.

21. The system of claim 1, wherein information regarding the plurality of users associated with the one or more documents is derived from contact information of an electronic address book.

22. The system of claim 1, wherein the computer system is coupled to a service provider network that includes a presence server that includes the presence information.

23. A method of communicating comprising:
retrieving a data file from a computer readable memory, the data file representing one or more documents that may be viewed by a plurality of users associated with the document;
executing a computer program on a computer system to open the one or more documents for display to at least one of the plurality of users; and
providing presence information for at least a subset of the plurality of users associated with the one or more documents.

24. The method of claim 23, wherein a first user opens the one or more documents and displays the one or more documents on a display device coupled to the computer system; and wherein the subset of the plurality of users includes each of the plurality of users except for the first user, such that the first user receives presence information of all of the other users associated with the one or more documents.

25. The method of claim 23, wherein presence information indicates whether a user is available to communicate through an identified communication mechanism.

26. The method of claim 23, wherein the one or more documents includes a subject, and wherein the subject is communicated to at least one of the plurality of users.

27. The method of claim 23, further comprising initiating a call to be placed to at least one of the plurality of users in response to a user selection made in response to display information provided in connection with the one or more documents.

28. The method of claim 27, wherein the display information includes a set of contacts that identify the plurality of users and presence information for each of the plurality of users.

29. The method of claim 28, wherein the presence information for a first user of the plurality of users identifies the first user as available for communication using a telephone device and wherein the call is placed and the subject is communicated over a service provider network to the telephone device.

30. The method of claim 29, wherein the user that opened the one or more documents communicates with the first user via a telephony connection while the first user is also viewing a version of the one or more documents at a display device.

31. The method of claim 23, further comprising receiving a topic of the call that is provided by a user and communicating the topic to a service provider network for display at a far-end telephone device.

32. A method comprising:
receiving a communication request at a communication device, the communication request including information extracted from a data file of one or more documents associated with presence information; and
displaying the information at the communication device.

33. The method of claim 32, wherein the communication request is received after an originator of the communication request accessed the presence information.

34. The method of claim 32, wherein the information includes subject information.

35. The method of claim 34, further comprising:
storing the information extracted from the data file in a selected category based on the received subject information.

36. The method of claim 34, further comprising:
storing data associated with the communication request in a log at the communication device.

37. The method of claim 32, further comprising:
displaying at least a portion of the one or more documents at the communication device.

38. A display system, comprising:
a display unit;
a document window to display a document on the display unit;
a presence window to display information on the display unit, the presence window including a plurality of display fields, the plurality of display fields including:
a user field to display a plurality of users associated with the document;
a communication method field to display a plurality of communication paths for each user, the plurality of communication paths including at least one wide area network communication path; and
a presence field to display whether at least one of the plurality of users is available for communication via at least one of the plurality of communication paths.

39. The display system of claim 38, wherein the wide area communication path is a publicly switched telephone network.
